(19) United States
(12) Patent Application Publication
(10) Pub. No.: US 2024/0411054 A1
(43) Pub. Date: Dec. 12, 2024

(54) Optical Film and Composite Optical Film

(71) Applicant: UBRIGHT OPTRONICS CORPORATION, Taoyuan City (TW)

(72) Inventors: Yi-Long Tyan, Taoyuan City (TW); Lung-Pin Hsin, Taoyuan City (TW); Ching-An Yang, Taoyuan City (TW); YING-CHIH LU, Taoyuan City (TW); RUEI-CIAN WU, Taoyuan City (TW); Chang-Yu Chou, Taoyuan City (TW)

(21) Appl. No.: 18/736,558

(22) Filed: Jun. 7, 2024

Related U.S. Application Data
(60) Provisional application No. 63/471,976, filed on Jun. 9, 2023.

(51) Int. Cl. G02B 1/11

(52) U.S. Cl. CPC G02B 1/11

(57) ABSTRACT

An optical film, comprising: a first substrate; a first plurality of prisms, disposed on the first substrate, wherein the first plurality of prisms comprises a first prism and a second prism adjacent to the first prism, wherein a first highest point of the first prism is higher than a second highest point of the second prism, wherein a top portion of an outer surface of the first prism comprises an arc shape with the arc shape comprise a highest point of the first prism.

### CROSS-REFERENCE TO RELATED APPLICATIONS

This application claims the benefit of U.S. provisional patent application No. 63/471,976, filed on Jun. 9, 2023, which is hereby incorporated herein by reference.

### BACKGROUND OF THE INVENTION

### 1. Field of the Invention

The present invention relates to an optical film, and more particularly to an optical film with prisms.

### 2. Description of Related Art

With the rapid advancement of technology, the pursuit of lighter, thinner, shorter, and smaller devices, along with demands for energy-saving and carbon reduction, has driven the development of electronic digital products towards lightweight, high-brightness, energy-efficient, and thin technologies. Consequently, in the development of display panels, under the environmental demands for energy saving and carbon reduction, various technologies have emerged to enhance the brightness of the optical films in backlight modules, thereby increasing the overall brightness of the panels.

Among these, the prism sheet optical film in the backlight module is a key component for enhancing brightness. It mainly uses the principles of refraction and reflection of light, utilizing the structure of the prism sheet to correct the direction of light, concentrating it in a single direction and recycling the scattered light, thereby greatly enhancing the overall brightness of the backlight module and achieving a brightening effect. However, as the brightness of the prism sheet increases, the scratch resistance at the top of the prism sheet decreases, affecting the assembly yield of the overall module.

Moreover, automotive modules have higher requirements for the brightness and weather resistance of prism sheets, especially under harsh conditions after undergoing thermal shock and vibration tests. The top structure of the prism sheet is prone to damage, resulting in abnormalities. Therefore, maintaining high brightness while also providing improved durability and performance of the prism sheet's top structure after thermal shock and vibration tests is a crucial factor in the design of prism sheets for automotive modules.

Accordingly, the present invention proposes a new solution to overcome the above-mentioned disadvantages.

### SUMMARY OF THE INVENTION

This invention relates to an optical film with a prism structure that incorporates a design featuring varying heights. The top of the prism is designed with rounded corners, which enhances the overall scratch resistance of the optical film while maintaining high brightness and improving the scratch resistance of the prism's top itself.

The invention combines high and low prism heights with rounded corner designs. In addition to being used as a standalone optical film, the invention can also be laminated in pairs or in groups of three or more. This configuration maintains the original brightness performance and provides a scratch-resistant prism structure design.

Currently, to overcome the wear and tear on the prism sheet's top structure after thermal shock and vibration tests, this invention introduces a rounded corner design at the top of the prism sheet with a radius (r) of 1-20 μm. However, this rounded corner design can result in a significant brightness reduction of 5-10%. As the radius of the rounded corner increases, the damage resistance of the top structure improves, but the brightness decreases accordingly. This reduction in brightness can prevent the automotive module from meeting its original design requirements, potentially leading to higher power consumption or an increased number of LEDs to meet the brightness needs, thereby significantly increasing energy consumption and module costs, which contradicts the energy-saving and carbon reduction (ESG) goals.

To meet the end customers' demands for high brightness and high scratch resistance in LCD panel products, this invention uses a combination of high-round-corner prism structures with low triangular prism structures. This design, which integrates rounded corners at the tip of the high triangular prism structure, maintains the original high brightness of the prism while significantly enhancing overall scratch resistance. Therefore, it effectively achieves (1) a reduction in the number of LEDs used, (2) improved overall power consumption of the backlight module, thereby fulfilling the ESG goals of energy saving and carbon reduction.

One objective of the present invention is to design a prism structure that combines high and low prism elements. This design specifically applies a rounded corner to the top of the high triangular prism structure, thereby maintaining the high brightness of the original triangular prism structure while significantly enhancing the scratch resistance of the entire prism.

This invention combines the high-low arrangement of triangular prisms with a rounded corner design. It can be used not only in single prism sheets but also in optical films formed by laminating two or more prism sheets. This design retains the original brightness performance while enhancing the scratch resistance of the high prism structure. The invention can be applied to the backlight modules of all LCD devices, making it suitable for smartphones, tablets, laptops, automotive displays, monitors, and TVs.

In one embodiment, the present invention discloses an optical film, wherein the optical film comprises: a first substrate; a first plurality of prisms, disposed on the first substrate, wherein the first plurality of prisms comprises a first prism and a second prism adjacent to the first prism, wherein a first highest point of the first prism is higher than a second highest point of the second prism, wherein a top portion of an outer surface of the first prism comprises an arc shape with the arc shape comprise a highest point of the first prism.

In one embodiment, the arc shape is a circular arc shape.

In one embodiment, the difference between the first height of the first prism and the second height of the second prism is 0.5˜5 μm.

In one embodiment, the difference between the first height of the first prism and the second height of the second prism is 1˜3 μm.

In one embodiment, the radius of the circular arc shape is 1-10 μm.

In one embodiment, the radius of the circular arc shape is 2˜6 μm.

In one embodiment, the second prism has a triangle shape with the top angle being in a range of 50 to 100 degree.

In one embodiment, the second prism has a triangle shape with the top angle being in a range of 85 to 95 degree.

In one embodiment, the substrate is made of PET.

In one embodiment, a photo-curable acrylic resin is coated on the PET, wherein the plurality of prisms are formed in the photo-curable acrylic resin with a refractive index between 1.48 and 1.80.

In one embodiment, the plurality of prisms comprises a plurality of first-type prisms and a plurality of second-type prisms, wherein a first highest point of the first-type prism is located higher than a second highest point of the second-type prism, wherein the plurality of first-type prisms and the plurality of second-type prisms are interleaved along an edge of the top surface of the first substrate, wherein a top portion of an outer surface of each of the first-type prisms comprises an arc shape with the arc shape comprise a highest point of the first prism.

In one embodiment, the plurality of prisms comprises a plurality of first-type prisms and a plurality of second-type prisms, wherein a first highest point of the first-type prism is located higher than a second highest point of the second-type prism, wherein for each two adjacent first-type prisms, there are two of the second-type prisms located between said two adjacent first-type prisms, wherein a top portion of an outer surface of each of the first-type prisms comprises an arc shape with the arc shape comprise a highest point of the first prism.

In one embodiment, an anti-reflective film is coated on the bottom surface of the substrate.

In one embodiment, the anti-reflective film is formed by a photo-curable acrylic resin or a thermal-curable acrylic resin, wherein a thickness the anti-reflective film is in a range of 1 to 8 μm.

In one embodiment, the anti-reflective film is formed by a photo-curable acrylic resin or a thermal-curable acrylic resin, wherein a thickness the anti-reflective film is in a range of 2 to 5 μm.

In one embodiment, a matte structure is coated on a bottom surface of the first substrate.

In one embodiment, the haze of the matte structure 2-60%, preferably 10-50%.

In one embodiment, the present invention discloses a composite optical film, wherein the composite optical film, comprises an optical film; and a brightness-enhancing film, comprising a second plurality of prisms, wherein the brightness-enhancing film is adhered to the optical film by an adhesive layer, in which a top part of the second plurality of prisms is submerged in the adhesive layer.

In one embodiment, the adhesive layer is formed by a photo-curable acrylic resin or a thermal-curable acrylic resin, wherein the haze of the adhesive layer is 1%˜60%.

In one embodiment, the adhesive layer is formed by a photo-curable acrylic resin or a thermal-curable acrylic resin, wherein the haze of the adhesive layer is 3˜40%.

The detailed technology and above preferred embodiments implemented for the present invention are described in the following paragraphs accompanying the appended drawings for people skilled in this field to well appreciate the features of the claimed invention.

### BRIEF DESCRIPTION OF THE DRAWINGS

The foregoing aspects and many of the accompanying advantages of this invention will become more readily appreciated as the same becomes better understood by reference to the following detailed description when taken in conjunction with the accompanying drawings, wherein:

FIG. 1A illustrates a schematic 3D view of an optical film in an embodiment of the present invention;

FIG. 1B illustrates a schematic cross-sectional view of an optical film in an embodiment of the present invention;

FIG. 1C illustrates a schematic enlarged cross-sectional view of an optical film in an embodiment of the present invention;

FIG. 2A illustrates a schematic 3D view of an optical film in an embodiment of the present invention;

FIG. 2B illustrates a schematic cross-sectional view of an optical film in an embodiment of the present invention;

FIG. 3A illustrates a schematic 3D view of a composite optical film in an embodiment of the present invention;

FIG. 3B illustrates a schematic cross-sectional view of the composite optical film in an embodiment of the present invention;

FIG. 3C illustrates a schematic cross-sectional view of the composite optical film in an embodiment of the present invention;

FIG. 4A illustrates a schematic 3D view of a composite optical film in an embodiment of the present invention;

FIG. 4B illustrates a schematic cross-sectional view of the composite optical film in an embodiment of the present invention;

FIG. 4C illustrates a schematic cross-sectional view of the composite optical film in an embodiment of the present invention;

FIG. 5 illustrates an enlarged real photo of an optical film in an embodiment of the present invention;

FIG. 6 illustrates a method to manufacture an optical film in an embodiment of the present invention;

FIG. 7 compares the friction test results between conventional technology and the technology of the present invention.

### DETAILED DESCRIPTION OF THE ILLUSTRATED EMBODIMENTS

The detailed explanation of the present invention is described as follows. The described preferred embodiments are presented for purposes of illustrations and descriptions, and they are not intended to limit the scope of the present invention.

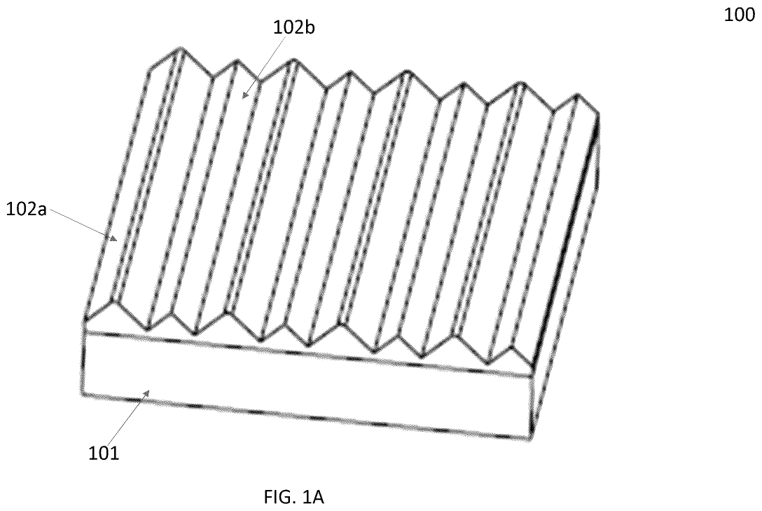

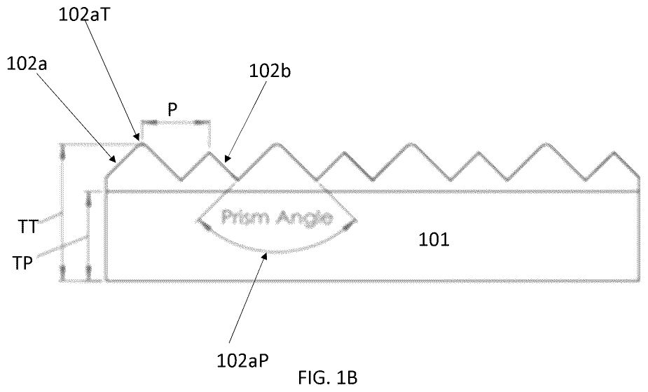

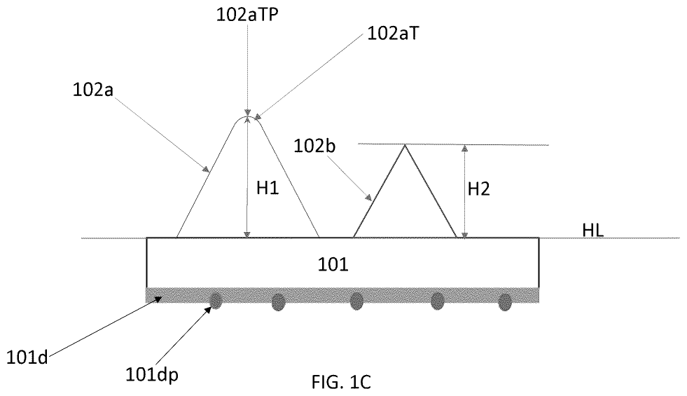

FIG. 1A illustrates a schematic 3D view of an optical film 100 in an embodiment of the present invention; FIG. 1B illustrates a schematic cross-sectional view of an optical film 100 in an embodiment of the present invention; FIG. 1C illustrates a schematic enlarged cross-sectional view of an optical film 100 in an embodiment of the present invention, wherein the optical film 100 comprises a substrate 101; a plurality of prisms 102a, 102b disposed on the substrate 101, wherein the plurality of prisms 102a, 102b comprises a first prism 102a and a second prism 102b adjacent to the first prism 102a, wherein a height H1 of the first prism 102a is greater than a height H2 of the second prism 102b, wherein a top portion 102aT of the outer surface of the first prism 102a comprises an arc shape with the top portion 102aT of the outer surface of the first prism 102a comprise a highest point 102aTP of the first prism 102a relative to a horizontal line HL passing through a top surface of the substrate 101.

In one embodiment, the difference between the first height H1 of the first prism 102a and the second height H2 of the second prism 102b is 0.5˜5 μm.

In one embodiment, the difference between the first height H1 of the first prism 102a and the second height H2 of the second prism 102b is 1˜3 μm.

In one embodiment, the arc shape is a circular arc shape.

In one embodiment, the circular radius of the circular arc shape is 1-10 μm.

In one embodiment, the circular radius of the circular arc shape is 2˜6 μm.

In one embodiment, as shown in FIG. 1B, the first prism 102a has a prism angle being in a range of 50-100 degrees.

In one embodiment, as shown in FIG. 1B, the first prism 102a has a prism angle being in a range of 85-95 degrees.

In one embodiment, the second prism 102b has a triangle shape a prism angle being in a range of 50-100 degrees.

In one embodiment, the second prism 102b has a triangle shape a prism angle being in a range of 85-95 degrees.

In one embodiment, as shown in FIG. 1B, the pitch P between the first prism 102a and the second prism 102b is in a range of 45-55 μm.

In one embodiment, as shown in FIG. 1B, the total thickness TP of the substrate 101 is between 60-150 μm.

In one embodiment, as shown in FIG. 1B, the total thickness TT of the substrate 101 and the prisms 102a is between 100-300 μm.

In one embodiment, as shown in FIG. 1B, the pitch P between the first prism 102a and the second prism 102b is in a range of 45-55 μm.

In one embodiment, an anti-reflective film is coated on the bottom surface of the substrate 101.

In one embodiment, a transparent resin is coated on a bottom surface of the substrate 101.

In one embodiment, a matte structure is coated on a bottom surface of the substrate 101.

In one embodiment, a material comprising diffusion particles is coated on the bottom surface of the substrate 101 to form the matte structure on the bottom surface of the substrate 101.

In one embodiment, a material comprising diffusion beads is coated on the bottom surface of the substrate 101 to form a matte structure on the bottom surface of the substrate 101.

In one embodiment, the haze of the matte structure 2-60%, preferably 10-50%.

In one embodiment, as shown in FIG. 1C, a material comprising diffusion particles 101dp is coated on the bottom surface of the substrate 101 to form a diffusion layer 101d on the bottom surface of the substrate 101. In one embodiment, the diffusion layer 101d comprises a matte structure, wherein the haze of the matte structure 2-60%, preferably 10-40%.

In one embodiment, the diffusion particles comprises organic particles, such as PMMA, PS, Melamine, etc., wherein the haze of the diffusion layer formed by the diffusion particles is 2-60%. In one embodiment, the haze of the diffusion layer formed by the diffusion particles is 2-60% is 10-40%.

In one embodiment, the diffusion particles comprises organic particles, such as PMMA, PS, Melamine, etc., or an inorganic particle, such as Silicon, SiO2, TiO2, CaCO3, Al203, ZrO2, etc., or a mixture of the organic particles and the inorganic particles. The haze of the diffusion layer formed by the diffusion particles can be 2-60%, preferably 10-40%.

In one embodiment, an atomization structure is formed on the bottom surface of the substrate 101 by roller embossing, wherein the haze of the atomization structure can be 2-60%, and the best is 10˜50%.

In one embodiment, a high-transmittance hard coating (Hard Coating) is coated on the bottom surface of the substrate 101, the high-transmission hard coating has a low refractive index and can be formed by photo-curable or thermal-curable acrylate resin. The thickness of the high-transmission hard coating is between 1˜8 um, and the best is between 2˜5 um.

In one embodiment, the first substrate comprises at least one of the following: PET (polyethylene terephthalate), PEN (polyethylene naphtholate), PAR (polyacrylate), PC (polycarbonates), or TAC (cellulose triacetate).

In one embodiment, the lower prism structure can be triangular or semicircular, and the tip structure can be a wavy structure with a height difference or a left-right swing.

In one embodiment, If the lower prism structure is triangular, its angle is 50 to 100 degrees, and the best is 85 to 95 degree.

In one embodiment, two optical films 100 or 200 can be bonded into a single sheet. The bonding adhesive material can be a thermosetting resin or a UV-reactive resin. The thickness of the adhesive layer is controlled at 0.5˜1.5 um. The adhesion can be physical adhesion or chemical adhesion, and the adhesion force can reach more than 50 g/25 mm.

In one embodiment, the adhesive can be adhered using adhesive without added particles (beads). You can also use adhesive glue with added particles (beads) for bonding.

In one embodiment, if diffusion particles such as beads are used for coating, the diffusion particles can be organic particles, such as PMMA, PS, Melamine, etc., or inorganic particles, such as Silicon, SiO2, TiO2, CaCO3, Al203, ZrO2, etc., and the mist of the adhesive layer The degree can be controlled from 1% to 60%, and the optimal range is 3˜40%.

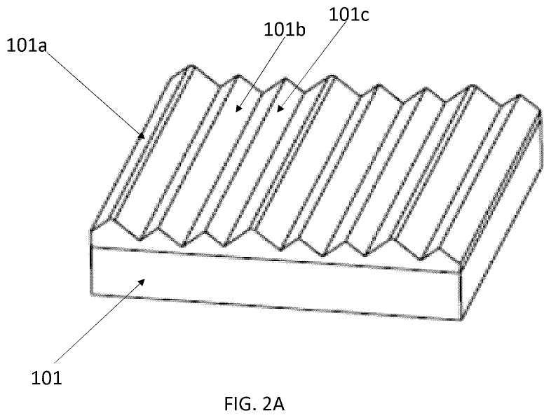

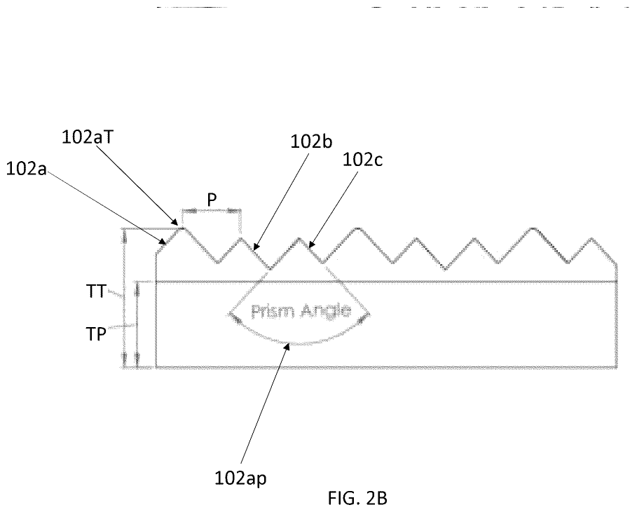

FIG. 2A illustrates a schematic 3D view of an optical film 200 in an embodiment of the present invention; FIG. 2B illustrates a schematic cross-sectional view of an optical film 100 in an embodiment of the present invention, wherein the optical film 100 comprises a substrate 101; a plurality of prisms 102a, 102b, 102c disposed on the substrate 101, wherein the plurality of prisms 102a, 102b, 102c comprises a first prism 102a, a second prism 102b adjacent to the first prism 102a, and a third prism 102c adjacent to the second prism 102b wherein a height H1 of the first prism 102a is greater than a height H2 of the second prism 102b, and the first height H1 of the first prism 102a is greater than a height H3 of the third prism 102c, wherein a top portion 102aT of the outer surface of the first prism 102a comprises an arc shape with the top portion 102aT of the outer surface of the first prism 102a comprise a highest point 102aTP of the first prism 102a relative to a horizontal line HL passing through a top surface of the substrate 101. In one embodiment, the height H2 of the second prism 102b is equal to the height H3 of the third prism 102c.

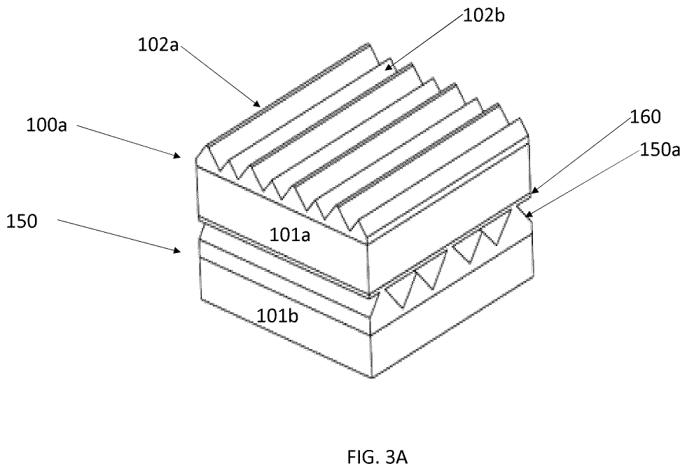

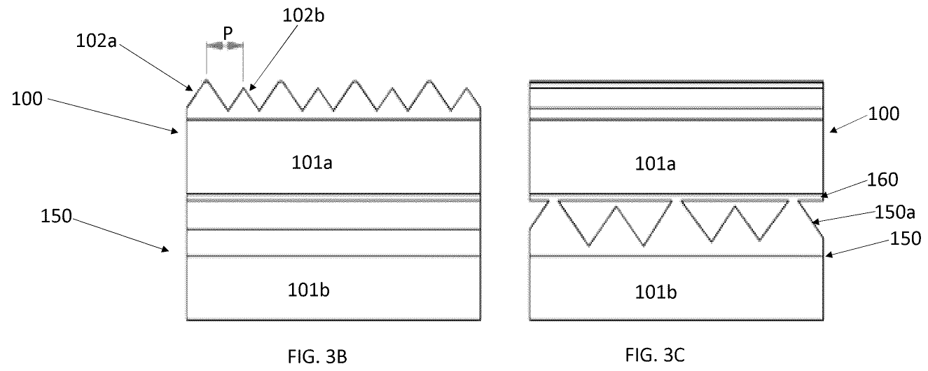

FIG. 3A illustrates a schematic 3D view of a composite optical film 300 in an embodiment of the present invention; FIG. 3B illustrates a schematic cross-sectional view of the composite optical film 300 in an embodiment of the present invention, FIG. 3C illustrates a schematic cross-sectional view of the composite optical film 300 in an embodiment of the present invention, wherein the composite optical film 300 comprises an optical film 100 as shown in FIG. 1A-1C; and a brightness enhancement film 150.

In one embodiment, the brightness enhancement film 150 comprises a substrate 101b and a plurality of prisms 150a on the substrate 101b, wherein an adhesive layer is disposed on the bottom surface of the optical film 100, wherein a top part of the plurality of prisms 150a is disposed inside the adhesive layer 160.

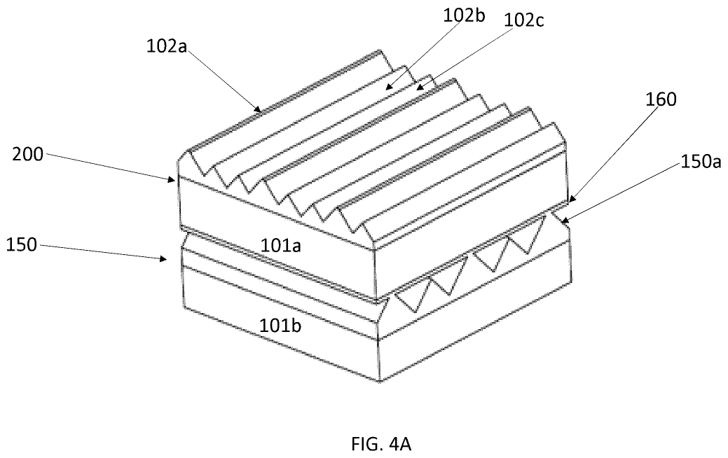

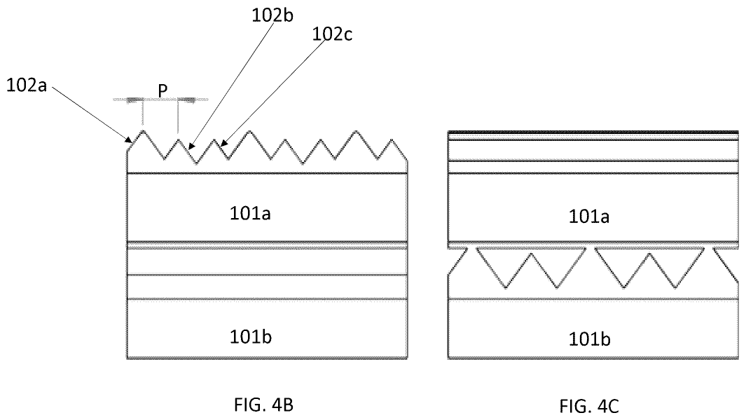

FIG. 4A illustrates a schematic 3D view of a composite optical film 400 in an embodiment of the present invention; FIG. 4B illustrates a schematic cross-sectional view of the composite optical film 400 in an embodiment of the present invention, FIG. 4C illustrates a schematic cross-sectional view of the composite optical film 400 in an embodiment of the present invention, wherein the composite optical film 400 comprises an optical film 200 as shown in FIG. 2A-2C; and a brightness enhancement film 150.

In one embodiment, the brightness enhancement film 150 comprises a substrate 101b and a plurality of prisms 150a on the substrate 101b, wherein a top part of the plurality of prisms 150a is disposed inside the optical film 200.

In one embodiment, the brightness enhancement film 150 comprises a substrate and a plurality of prisms 150a on the substrate 101b, wherein an adhesive layer is disposed on the bottom surface of the optical film 200, wherein a top part of the plurality of prisms 150a is disposed inside the adhesive layer 160.

The adhesive layer 160 can be made of a unitary/homogeneous material. Optionally, the unitary/homogeneous material can include light-diffusing particles or can't include light-diffusing particles. The thickness of the adhesive layer 160 can be 0.1˜10 μm or 0.1˜5 μm, preferably, 0.1˜2 μm, more preferably, 0.5˜1 μm.

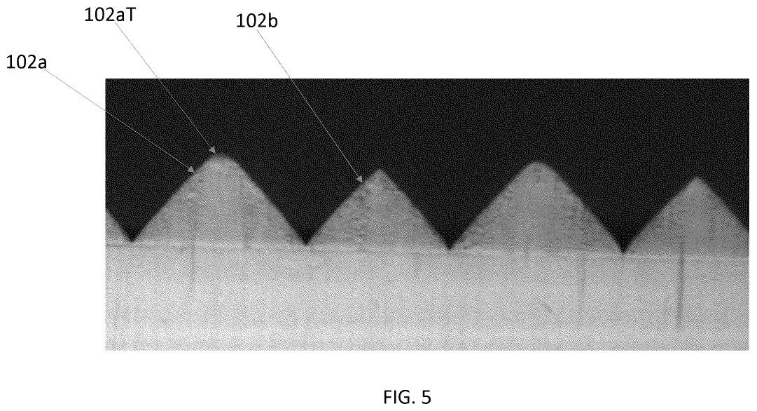

FIG. 5 illustrates a real photo of local region of the optical film 100 as shown in FIG. 1A of the present invention.

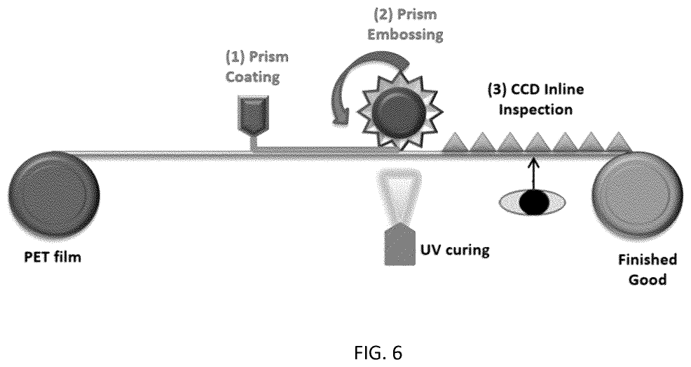

FIG. 6 illustrates a method to manufacture an optical film 100 in an embodiment of the present invention, different examples are described below.

### Example 1

Step 1: Fabricate a prism structure roller with prism groove Pitch=50 μm. The prism structure follows a one-high-one-low sequence, with a height difference of 3 μm between the high and low parts. Apply a rounded corner to the top of the high prism, with a radius R=4 μm on the roller structure.

Step 2: Prepare UV acrylic adhesive for forming the prism.

Step 3: Coat the surface of PET with UV acrylic adhesive and use the roller to emboss the prism structure, producing an optical film with a Pitch of 50 μm, designated as JJR507FAD_R4, as shown in Table 1-1.

### Example 2

Step 1: Fabricate a prism structure roller with prism groove Pitch=50 μm. The prism structure follows a one-high-two-low sequence, with a height difference of 3 μm between the high and low parts. Apply a rounded corner to the top of the high prism, with a radius R=4 μm on the roller structure.

Step 2: Prepare UV acrylic adhesive for forming the prism.

Step 3: Coat the surface of PET with UV acrylic adhesive and use the roller to emboss the prism structure, producing an optical film with a Pitch of 50 μm, designated as JJR507CFAD_R4, as shown in Table 1-1.

### Example 3

Laminate a brightness enhancement film with the optical film produced in Example 1. In this lamination process, the tip of the brightness enhancement film is inserted into the optical film produced in Example 1.

### Example 4

Laminate a brightness enhancement film with the optical film produced in Example 2. In this lamination process, the tip of the brightness enhancement film is inserted into the optical film produced in Example 2.

The invention provides an optical product with a prism design featuring high and low undulations combined with rounded corner designs. When combined with DBEF, it presents a structure composed of three optical film layers.

The brightness analysis shows that compared to the conventional product H507FAD developed using known techniques (100.00% brightness), adopting Example 1's JR507CFAD to enhance scratch resistance increases the brightness by 1.1%. If Example 2's prism design, featuring one high and two low parts combined with rounded corners at the top of the high prism (R=4 um), is used (JJR507CFAD_R4), the brightness can be increased by 2.0% compared to the conventional product H507FAD developed using previous techniques, as shown in Table 1 below.

This invention is an optical product with a prism design featuring high and low undulations combined with rounded corner designs. Friction tests with DBEF5 friction films were conducted according to the method shown in FIG. 6. Using products made with previous techniques as the baseline, after one back-and-forth friction cycle under a 200 g load, noticeable scratches appeared on the prism. As the load increased to 500 g and 1000 g, the extent of damage to the prism became more pronounced.

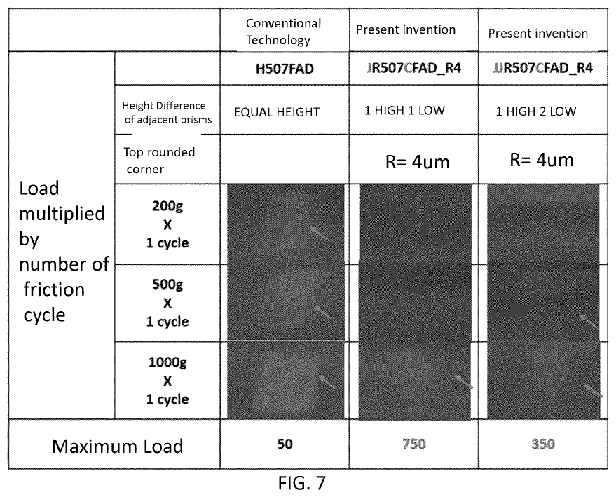

FIG. 7 compares the friction test results between conventional technology and the technology of the present invention.

As shown in FIG. 7, for example 1's (JR507CFAD_R4), under a 500 g load and after one back-and-forth friction cycle, no scratches appeared on the prism. When the load increased to 1000 g, the prism began to show slight damage, which was less noticeable than the product made with previous techniques under a 200 g load. This demonstrates that the structure of example 1's (JR507CFAD_R4) can effectively and significantly improve the scratch resistance of the prism. Moreover, its luminance is also 1.1% higher than the conventional product: H507FAD.

For example, 2's, JJR507CFAD_R4, after one back-and-forth friction cycle under a 200 g load, no scratches appeared on the prism. When the load increased to 500 g and 1000 g, the prism began to show extremely slight scratches, which were also less pronounced than those on the product made with previous techniques under a 200 g load. This indicates that the structure of example 2's, JJR507CFAD_R4, can effectively and significantly improve the scratch resistance of the prism. Additionally, its luminance is also 2.0% higher than the product H507FAD made with conventional technology.

Compared to conventional designs, this invention has the following characteristics: The top of the prism structure features a rounded corner design; the prisms are arranged in a high-low pattern; there is no reduction in brightness; scratch resistance is significantly enhanced; and the prisms remain intact after environmental tests such as thermal shock and vibration.

TABLE 1
Optical performance of the present invention
compared with conventional technology

| | | Conventional | | |
|---|---|---|---|---|
| | | Technology | Present invention | Present invention |
| (1) | | LCD Reflective Brightness Enhancement Film | | |
| Prism | Height | EQUAL HEIGHT | 1 HIGH 1 LOW | 1 HIGH 2 LOW |
| Structure | difference of | | | |
| | adjacent | | | |
| | prisms | | | |
| | Top rounded | | The top of the high | The top of the high |
| | corner | | part is rounded | part is rounded |
| | | | (R = 4 um) | (R = 4 um) |

| (2) Prism | H507FADS | JR507CFAD_R4 | JJR507CFAD_R4 |
|---|---|---|---|
| (3) Diffuser | Diffuser | | |
| luminance gain value % | 100% | 101.15% | 102.03% |

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An optical film, comprising:
a first substrate; and
a first plurality of prisms, disposed on the first substrate, wherein the first plurality of prisms comprises a first prism and a second prism adjacent to the first prism, wherein a first highest point of the first prism is higher than a second highest point of the second prism, wherein a top portion of an outer surface of the first prism comprises an arc shape with the arc shape comprise a highest point of the first prism.

2. The optical film according to claim 1, wherein the arc shape is a circular arc shape.

3. The optical film according to claim 1, wherein the difference between the first height of the first prism and the second height of the second prism is 0.5˜5 μm.

4. The optical film according to claim 1, wherein the difference between the first height of the first prism and the second height of the second prism is 1˜3 μm.

5. The optical film according to claim 1, wherein the radius of the circular arc shape is 1-20 μm.

6. The optical film according to claim 1, wherein the radius of the circular arc shape is 2˜6 μm.

7. The optical film according to claim 1, wherein the second prism has a triangle shape with the top angle being in a range of 50 to 100 degree.

8. The optical film according to claim 1, wherein the second prism has a triangle shape with the top angle being in a range of 85 to 95 degree.

9. The optical film according to claim 1, wherein the first substrate is made of PET.

10. The optical film according to claim 9, wherein a photo-curable acrylic resin is coated on the PET, wherein the plurality of prisms are formed in the photo-curable acrylic resin with a refractive index between 1.48 and 1.80.

11. The optical film according to claim 1, wherein the plurality of prisms comprises a plurality of first-type prisms and a plurality of second-type prisms, wherein a first highest point of the first-type prism is located higher than a second highest point of the second-type prism, wherein the plurality of first-type prisms and the plurality of second-type prisms are interleaved along an edge of the top surface of the first substrate, wherein a top portion of an outer surface of each of the first-type prisms comprises an arc shape with the arc shape comprise a highest point of the first prism.

12. The optical film according to claim 1, wherein the plurality of prisms comprises a plurality of first-type prisms and a plurality of second-type prisms, wherein a first highest point of the first-type prism is located higher than a second highest point of the second-type prism, wherein for each two adjacent first-type prisms, there are two of the second-type prisms located between said two adjacent first-type prisms, wherein a top portion of an outer surface of each of the first-type prisms comprises an arc shape with the arc shape comprise a highest point of the first prism.

13. The optical film according to claim 1, wherein an anti-reflective film is coated on the bottom surface of the substrate.

14. The optical film according to claim 1, wherein the anti-reflective film is formed by a photo-curable acrylic resin or a thermal-curable acrylic resin, wherein a thickness the anti-reflective film is in a range of 1 to 8 μm.

15. The optical film according to claim 1, wherein the anti-reflective film is formed by a photo-curable acrylic resin or a thermal-curable acrylic resin, wherein a thickness the anti-reflective film is in a range of 2 to 5 μm.

16. The optical film according to claim 1, wherein a matte structure is coated on a bottom surface of the first substrate.

17. The optical film according to claim 16, wherein the haze of the matte structure 2-60%, preferably 10-50%.

18. A composite optical film, comprising
an optical film, recited as in claim 1; and
a brightness-enhancing film, comprising a second plurality of prisms, wherein the brightness-enhancing film is adhered to the optical film by an adhesive layer, in which a top part of the second plurality of prisms is submerged in the adhesive layer.

19. The optical film according to claim 18, wherein the adhesive layer is formed by a photo-curable acrylic resin or a thermal-curable acrylic resin, wherein the haze of the adhesive layer is 1%˜60%.

20. The optical film according to claim 18, wherein the adhesive layer is formed by a photo-curable acrylic resin or a thermal-curable acrylic resin, wherein the haze of the adhesive layer is 3˜40%.
